(19) United States
(12) Patent Application Publication
(10) Pub. No.: US 2006/0153342 A1
(43) Pub. Date: Jul. 13, 2006

(54) Emergency call system

(75) Inventor: Syouichi Sasaki, Tokyo (JP)

Correspondence Address: VENABLE LLP, P.O. BOX 34385, WASHINGTON, DC, 20045-9998, US

(73) Assignee: Oki Electric Industry Co., Ltd., Tokyo (JP)

(21) Appl. No.: 11/312,768

(22) Filed: Dec. 21, 2005

(30) Foreign Application Priority Data
Jan. 7, 2005 (JP) 2005-002881

(51) Int. Cl. H04M 11/04

(52) U.S. Cl. 379/37; 379/45

(57) ABSTRACT

An emergency call system includes a private branch exchange which includes a channel section, a storage, and a controller, wherein when any of the plurality of extension terminals originates an emergency call using a representative telephone number of the private branch exchange to a command system, the channel section establishes a channel which enables communication between an emergency call extension terminal and the command system, and wherein when the emergency call extension terminal disconnects the emergency call during the emergency call in-progress state, the channel section disconnects a channel to the emergency call extension terminal and keeps connecting a channel to the public network, thereby establishing an emergency call line-hold state.

### BACKGROUND OF THE INVENTION

1. Field of the Invention

The present invention relates to an emergency call system that can adequately handle an emergency call made by an extension terminal.

2. Description of the Related Art

An emergency call service is one type of telephone service for use in emergency, such as a-crime reporting, a fire reporting, an accident reporting or an ambulance calling. A command system in an emergency call receiving organization such as the police, the Maritime Safety Agency (the coast guards), and the fire department should maintain the emergency call (that is, should have a line-hold function) even after the emergency caller using an extension terminal disconnects the emergency call unless the emergency call receiving organization disconnects the emergency call. Moreover, the emergency call receiving organization must be able to talk to the emergency caller (that is, must have a call-back function) even after the emergency caller disconnects the emergency call so that the emergency call is placed in the line-hold state.

The line-hold function and the call-back function in a telephone switching system including a private branch exchange (PBX) are described, for example, in Japanese Patent Application Kokai (Laid-Open) Publication No. 02-228865.

In the conventional fixed-line phone system, since a telephone line is assigned to a call physically (electrically), it is easy to keep the line-hold state.

However, a PBX is connected to a plurality of extension terminals disposed in different places, and only the representative telephone number given to the PBX is reported to the command system in the emergency call receiving organization. Therefore, even if the command system in the emergency call receiving organization narrows the possible area of the crime, fire, or accident in accordance with the representative telephone number of the PBX, the area does not match the place of the extension terminal occasionally.

A solution might be to notify the command system in the emergency call receiving organization of an extension telephone number assigned to the extension terminal of the emergency caller. Unlike the conventional fixed-line telephone, the extension telephone number of the extension terminal connected to the PBX is not a telephone number indicating the physical place, such as an out-of-town office number and a local office number, but is just a number not indicating the physical place. Accordingly, the emergency call receiving organization cannot specify the position of the extension terminal even if the extension telephone number is reported to the command system in the emergency call receiving organization.

Furthermore, although an extension terminal includes a wired terminal such as an analog telephone or an Integrated Services Digital Network (ISDN) telephone, it may also be a wireless mobile terminal such as a Personal Handyphone System (PHS) terminal which is a terminal used in a microcellular telephone system. Since a wireless mobile terminal can be used in different places, an emergency caller who has made an emergency call to an emergency call receiving organization from the wireless mobile terminal may disconnect the emergency call and then move to another place with the wireless mobile terminal in the line-hold state. Some PBXs cannot have a call-back function that allows the command system in the emergency call receiving organization to call back the wireless mobile terminal of the emergency caller again after the emergency caller moves with the wireless mobile terminal.

### SUMMARY OF THE INVENTION

It is an object of the present invention to provide an emergency call system that can implement a line-hold function and a call-back function even when an emergency call is made by an extension terminal.

According to the present invention, an emergency call system includes a private branch exchange assigned a representative telephone number. The private branch exchange includes a channel section which connects or disconnects channels to a plurality of extension terminals, connects or disconnects a channel to a public network, and establishes a channel between the plurality of extension terminals and the public network; a storage which stores emergency call information including identification information of the plurality of extension terminals; and a controller which controls an operation of the channel section and the storage. When any of the plurality of extension terminals originates an emergency call using the representative telephone number of the private branch exchange to a command system assigned an emergency telephone number, the channel section establishes a channel which enables communication between an emergency call extension terminal which is the extension terminal originating the emergency call and the command system, and the storage stores identification information of the emergency call extension terminal and emergency call in-progress state information indicating the emergency call communication between the emergency call extension terminal and the command system is in progress. When the emergency call extension terminal disconnects the emergency call during the emergency call in-progress state, the channel section disconnects a channel to the emergency call extension terminal and keeps connecting a channel to the public network, thereby establishing an emergency call line-hold state, the storage stores emergency call line-hold state information and deletes the emergency call in-progress state information.

Furthermore, the emergency call system may further includes a subscriber information database which contains subscriber information of a subscriber to a telephone service in the public network; a call processing database which contains registered subscriber information of a registered subscriber whose private branch exchange is connected to public network and turned on; a line-hold device which holds a line between the private branch exchange and the command system during the emergency call line-hold state; and an IP phone switching device which is connected to the public network and switches a connection among the private branch exchange, the subscriber information database, the call processing database, the line-hold device, and the command system.

According to the present invention, an emergency call line-hold function can be appropriately implemented even when an emergency call is transmitted from an extension terminal through a private branch exchange and a public network to a command system using a representative telephone number of the private branch exchange.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1A is a block diagram showing a configuration including an emergency call system according to the first embodiment of the present invention, and FIG. 1B is a PBX shown in FIG. 1A;

FIG. 2 shows a structure of management information of a call processing database in the first embodiment;

FIG. 3 shows a structure of management information of a subscriber information database in the first embodiment;

FIG. 4 is a sequence diagram showing a process of registration of a PBX to a subscriber information database and a call processing database in the first embodiment;

FIG. 5 is a sequence diagram showing a process of registration of a mobile terminal to a PBX in the first embodiment;

FIG. 6 is a sequence diagram showing a process performed by the emergency call system when a subscriber makes an emergency call from a mobile terminal to an emergency call receiving organization in the first embodiment;

FIG. 7 is a sequence diagram showing a process performed by the emergency call system when an emergency caller disconnects an emergency call using a mobile terminal in the first embodiment;

FIG. 8 is a sequence diagram showing a process performed by the emergency call system when a new outgoing call is originated from a mobile terminal during the “emergency call line-hold state” in the first embodiment;

FIG. 9 is a sequence diagram showing a process performed by the emergency call system when an incoming call request to a PBX from a third party occurs during the “emergency call line-hold state” in the first embodiment;

FIG. 10 is a sequence diagram showing a process performed by the emergency call system when a command system in the emergency call receiving organization calls back a subscriber during the “emergency call line-hold state” in the first embodiment; and

FIG. 11 is a sequence diagram showing a process performed by the emergency call system when a command system in the emergency call receiving organization calls back a subscriber, whose mobile phone is busy with a call between the subscriber and a third party, during the “emergency call line-hold state” in the second embodiment of the present invention.

### DETAILED DESCRIPTION OF THE INVENTION

Further scope of applicability of the present invention will become apparent from the detailed description given hereinafter. However, it should be understood that the detailed description and specific examples, while indicating preferred embodiments of the invention, are given by way of illustration only, since various changes and modifications will become apparent to those skilled in the art from the detailed description.

### First Embodiment

An emergency call system according to the first embodiment of the present invention will be described with reference to the drawings. The emergency call system according to the first embodiment makes an emergency call through an Internet Protocol (IP) phone network to an emergency call command system (hereinafter referred to as a command system) in an emergency call receiving organization such as the police, the Maritime Safety Agency (the coast guards), and the fire department.

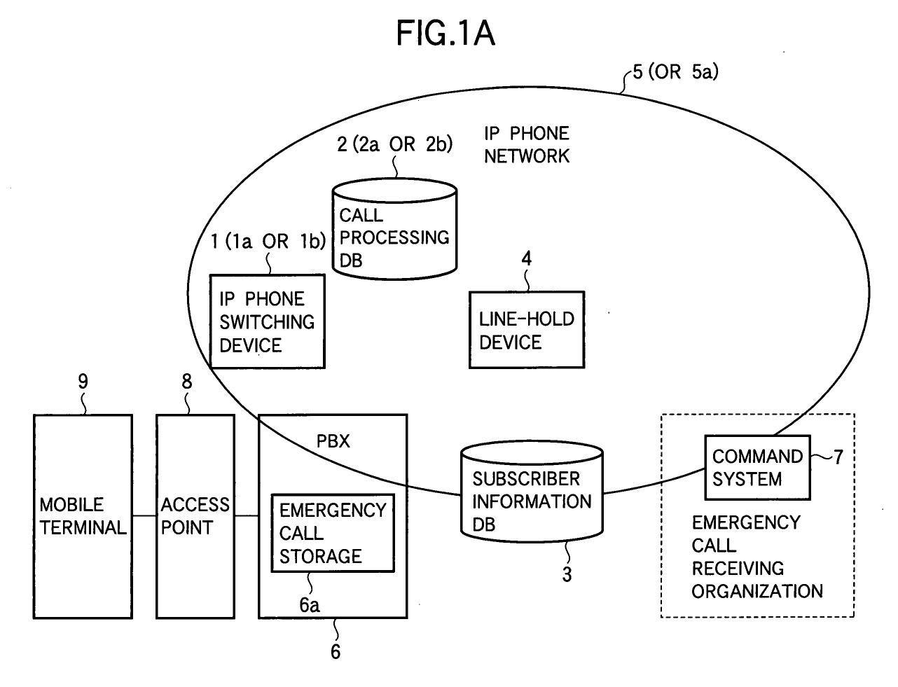

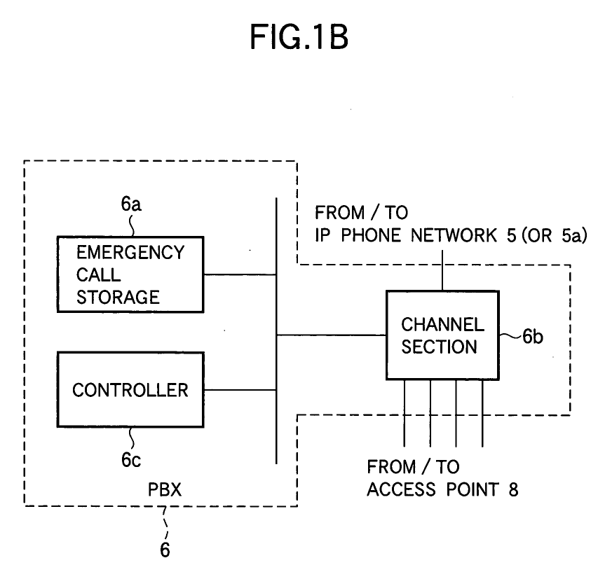

FIG. 1A is a block diagram showing a configuration including an emergency call system which is part of an IP phone system according to the first embodiment, and FIG. 1B is a private branch exchange (PBX) shown in FIG. 1A.

Referring to FIG. 1A, one or more IP phone switching devices 1 (1a or 1b), one or more call processing databases (DBs) 2 (2a or 2b), a subscriber information database (DB) 3, and a line-hold device 4 are connected to (or constitute) an IP phone network 5 (or 5a) as a public network. The IP phone switching device 1 is used when a company (or a carrier) offers an IP phone service to the telephone subscribers. The call processing database (DB) 2 is used by the IP phone switching device 1 to offer the IP phone service. The subscriber information database 3 manages information of the subscribers to the IP phone service. The line-hold device 4 supports the implementation of a line-hold function in the emergency call system according to the first embodiment.

Referring to FIG. 1A, a subscriber (or a subscriber's system) to an IP phone service in the emergency call system according to the first embodiment has one or more private branch exchanges (PBXs) 6, one or more access points 8 connected to the PBX 6, and one or more mobile terminals 9 which are one or more extension terminals such as a mobile telephone. The mobile terminal 9 is connected to the PBX 6 via the access point 8, and the PBX 6 is connected to the IP phone network 5.

Referring to FIG. 1A, the emergency call receiving organization has a command system 7 connected to the IP phone network 5 to handle an emergency call.

Referring to FIG. 1B, the PBX 6 is assigned a representative telephone number and includes a channel section 6b which establishes a channel between a plurality of extension terminals 9 and the IP phone network 5, an emergency call storage 6b such as a memory which stores emergency call information including identification information of the plurality of extension terminals 9, and a controller 6c which controls an operation of the channel section and the storage.

The access point 8 has the same configuration as the conventional access point. Further, the mobile terminal 9 has the same configuration as the conventional mobile terminal. Except that an emergency call function implemented by, for example, software has been improved, the PBX 6 generally has the same configuration as the conventional PBX.

The mobile terminal 9 may be compatible with the IP network 5. Alternatively, the mobile terminal 9 which is not compatible with the IP network 5 may be used with the access point 8 which is compatible with the IP network 5. Furthermore, the mobile terminal 9 and access point 8, both of which are not compatible with the IP network 5, may be used with the PBX 6 which has a processor on the side of the outside line and is compatible with the IP network 5.

Although the IP phone switching device 1 has almost the same hardware configuration as the conventional one, the IP phone switching device 1 is different from the conventional one in a point that the emergency call processing is added as the call processing implemented mainly by software.

The line-hold device 4 may be configured to implement the same call processing as that implemented by the IP phone. The IP phone means a softphone, a combination of an analog telephone and a gateway, or the like. One or more line-hold devices 4 may be connected to the IP phone network 5. If a plurality of line-hold devices 4 is connected to the IP phone network 5, each line-hold devices may be provided for individual emergency call receiving organizations such as the police (an emergency telephone number ‘110’ in Japan), the Maritime Safety Agency (an emergency telephone number ‘118’ in Japan) and the fire department (an emergency telephone number ‘119’ in Japan). Alternatively, a single line-hold device 4 with a plurality of IP addresses or communication interfaces may be used to assist the simultaneous holding of a plurality of telephone lines.

Each of the call processing database 2 and the subscriber information database 3 has a general database configuration that allows access from an external device.

The call processing database 2 may be provided for each IP phone switching device 1 in a one-to-one relationship. The IP phone switching device 1 and the call processing database 2 provided in a one-to-one relationship may be integrated into one device or may be directly connected by a private line.

Just one subscriber information database 3 may be provided for each carrier providing an IP phone service, that is, for each IP phone network 5. A plurality of subscriber information databases 3 of one carrier may be distributed over the IP phone network 5.

The command system 7 has a monitor and a keyboard or console, and has a hardware configuration and a software configuration that allow almost the same call processing functions to be implemented as the IP phone except for the following points. In addition to the same functions as the IP phone, the command system 7 has a function of switching a voice connection destination and a function of sending a call signal for call-back. Although the command system 7 shown in FIG. 1 is connected directly to the IP phone network 5, the command system 7 may be compatible with the current telephone network and the connection of the command system 7 to the IP phone network 5 may be controlled by a gateway. In other words, the command system 7 shown in FIG. 1 may be replaced by a combination of another command system and a gateway.

The PBX 6 assigned a representative telephone number has the following function. When any of the plurality of extension terminals originates an emergency call using the representative telephone number of the PBX 6 to the command system 7 assigned an emergency telephone number, the channel section 6b of the PBX 6 establishes a channel which enables communication between an emergency call extension terminal which is the extension terminal originating the emergency call and the command system 7, and the emergency call storage 6a of the PBX 6 stores identification information of the emergency call extension terminal and emergency call in-progress state information indicating the emergency call communication between the emergency call extension terminal and the command system 7 is in progress. Furthermore, when the emergency call extension terminal disconnects the emergency call during the “emergency call in-progress state”, the channel section 6b disconnects a channel to the emergency call extension terminal and keeps connecting a channel to the public network 5, thereby establishing an emergency call line-hold state, the emergency call storage 6a stores emergency call line-hold state information and deletes the emergency call in-progress state information.

Further, the call processing database 2 and the subscriber information database 3 can be integrated into a single database. Furthermore, the call processing database 2 and/or the subscriber information database 3 can be incorporated into the IP phone switching device 1. Moreover, the line-hold device 4 can be incorporated into the PBX 6 or the IP phone switching device 1.

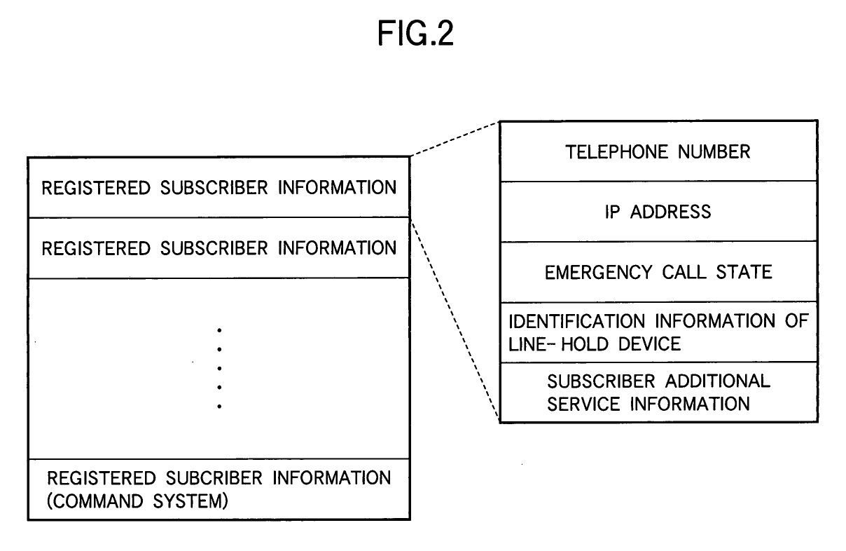

FIG. 2 shows a structure of management information of the call processing database 2 in the first embodiment.

Referring to FIG. 2, the call processing database 2 contains subscriber information necessary for call processing of each subscriber who has been registered. The registered subscriber information of each subscriber (each IP phone including a PBX) served by the IP phone switching device 1 includes at least: a telephone number and an IP address, each of which identify the registered subscriber; an emergency call state indicating whether or not the subscriber is in the middle of the “emergency call in-progress state” which means that the emergency call communication between the emergency call extension terminal and the command system 7 is in progress; identification information of the line-hold device 4 such as an IP address for identifying the line-hold device 4, which is used for line-holding when the emergency call system is in the “emergency call line-hold state”; and subscriber additional service information regarding additional service contracted by the subscriber such as a telephone call transfer, a transmission-only function, and a telephone call without number notification.

Furthermore, the registered subscriber information managed by the call processing database 2 includes the registered subscriber information of the command system 7 in the emergency call receiving organization. The call processing database 2 is preferable to manage the registered subscriber information of the command system 7 in a special area for exclusive use and permit a limited maintenance personal to rewrite the information.

Moreover, with regard to the PBX 6, the representative telephone number of the PBX 6 is specified in the telephone number field of the registered subscriber information.

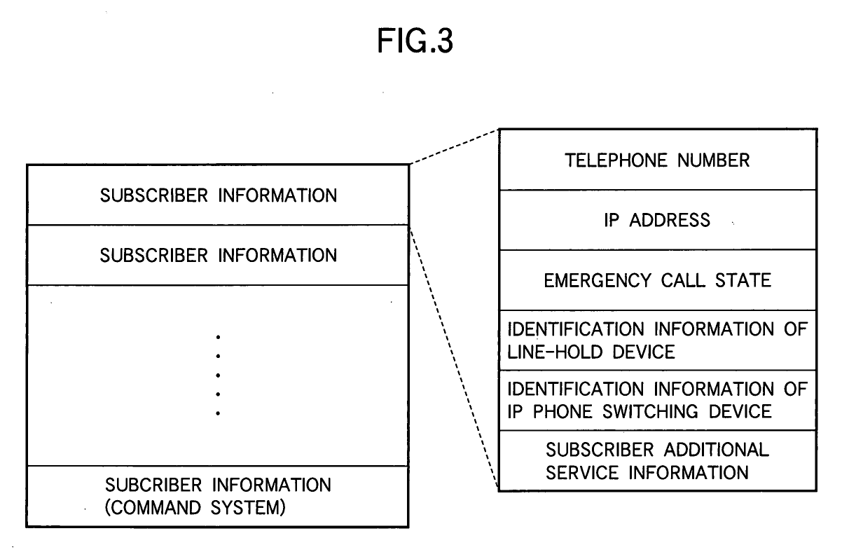

FIG. 3 shows a structure of management information of the subscriber information database 3 in the first embodiment.

Referring to FIG. 3, the subscriber information database 3 manages at least the following information of each subscriber to a telephone service in the IP phone network 5. The information managed by the subscriber information database 3 includes at least: a telephone number and an IP address, each of which identifies the subscriber; an emergency call state indicating whether or not the subscriber is in the middle of the “emergency call in-progress state” which means that the emergency call communication between the emergency call extension terminal and the command system 7 is in progress; identification information of the line-hold device 4 such as an IP address for identifying the line-hold device 4 which is used for line-holding when the emergency call system is in the “emergency call line-hold state”; identification information of an IP phone switching device 1 serving the subscriber at present; and subscriber additional service information regarding additional service contracted by the subscriber such as a telephone call transfer, a transmission-only function, and a telephone call without number notification.

The subscriber information managed by the subscriber information database 3 also includes the subscriber information of the command system 7 in the emergency call receiving organization. The subscriber information database 3 is preferable to manage the subscriber information of the command system 7 in a special area for exclusive use and permit a limited maintenance personal to rewrite the information.

Moreover, with regard to the PBX 6, the representative telephone number of the PBX 6 is specified in the telephone number field of the subscriber information managed by the subscriber information database 3. If the PBX 6 has a plurality of representative telephone numbers, the corresponding number of subscriber information items is provided in the subscriber information database 3.

The call processing database 2 and the subscriber information database 3 are nonvolatile storage devices so that the information held in the databases will not disappear after rebooting or power-down.

When the PBX 6 connected to the IP phone network 5 is turned on or the PBX 6 being turned on is connected to the IP phone network 5, the IP address and representative telephone number assigned to the PBX 6 are sent to the IP phone network 5 to request an entry (or a registration) to the IP phone switching device 1. The PBX 6 becomes available after it receives a reply indicating a success of the entry from the IP phone switching device 1. Although the Voice over Internet Protocol (VoIP) signaling protocol used in the IP phone network 5 is not limited to the Session Initiation Protocol (SIP), the use of the SIP is assumed in the subsequent description of functions and operations in the first embodiment.

When an emergency call is made from the mobile terminal 9 by an emergency caller, the PBX 6 serving the mobile terminal 9 stores the emergency telephone number as a special telephone number in association with the identification information of the mobile terminal 9, such as an extension number, an IP address, or an Media Access Control (MAC) address, in the emergency call storage 6a. The PBX 6 (the channel section 6b) has a function of sending an emergency call through an outside telephone line using the representative telephone number to the IP phone network 5. The PBX 6 also has a function of searching for an access point 8 serving the mobile terminal 9 in accordance with the identification information such as an extension number of the mobile terminal 9 stored in the emergency call storage 6a and establishing an extension call connection accordingly when a call-back instruction is received through the IP phone network 5 during the “emergency call line-hold state.”

The IP phone switching device 1 has a function of receiving an entry request from the PBX 6 and the command system 7, searching through the subscriber information database 3 for a subscriber having the same telephone number, and, if there is a match, entering the IP address and identification information of the IP phone switching device 1 received together with the entry request to an area of the corresponding subscriber information in the subscriber information database 3. The IP phone switching device 1 also has a function of storing the telephone number and the IP address, each of which identifies the subscriber, and the information of additional services used by the subscriber in the call processing database 2 used by the IP phone switching device 1, and notifying the PBX 6 or the command system 7 of a success of the entry.

Further, when a subscriber (i.e., an emergency caller) originates an emergency call, the IP phone switching device 1 has a function of acquiring information of the command system 7 from the subscriber information database 3 and connecting the IP phone switching device 1 serving the command system 7 to the command system 7. The IP phone switching device 1 also has a function of setting the emergency call state of the corresponding subscriber to the “emergency call in-progress state” in the subscriber information database 3 and the call processing database 2.

Furthermore, when a subscriber (i.e., an emergency caller) in the “emergency call in-progress state” disconnects the call, the IP phone switching device 1 has a function of ordering the command system 7 to switch the connection destination from the IP phone switching device 1 to the line-hold device 4. The IP phone switching device 1 also has a function of setting the emergency call state of the corresponding subscriber to the “emergency call line-hold state” in the call processing database 2 and the subscriber information database 3 and specifying identification information of the connected line-hold device 4.

Moreover, when the emergency caller in the “emergency call line-hold state” originates a new call, the IP phone switching device 1 has a function of issuing an instruction to switch a connection between the line-hold device 4 and the command system 7 to a connection between the IP phone of the emergency caller, including the PBX 6, and the command system 7, in accordance with the identification information of the line-hold device 4 stored in the call processing database 2. The IP phone switching device 1 also has a function of setting the emergency call state of the corresponding subscriber to the “emergency call in-progress state” in the call processing database 2 and the subscriber information database 3 and deleting information of the connected line-hold device 4.

When a third party using another system such as another IP phone places a call to the emergency caller during the “emergency call line-hold state”, the IP phone switching device 1 has a function of performing processing, assuming that the line of the emergency caller is busy. When the command system 7 issues a call-back instruction during the “emergency call line-hold state”, the IP phone switching device 1 has a function of calling the IP phone, including the PBX 6, of the emergency caller, irrespective of the additional service the user is using; if there is a reply, issuing an order to switch a connection between the line-hold device 4 and the command system 7 to a connection between the IP phone of the emergency caller and the command system 7, in accordance with the identification information of the line-hold device 4 stored in the call processing database 2. The IP phone switching device 1 also has a function of setting an emergency call state of the corresponding subscriber to the “emergency call in-progress state” in the call processing database 2 and the subscriber information database 3 and deleting the information of the connected line-hold device 4.

The line-hold device 4 has a function of holding a voice connection with the command system 7. The line-hold device 4 also has a function of establishing and releasing a voice connection with the command system 7, as controlled by the IP phone switching device 1.

Furthermore, when an IP packet related to an emergency call is sent or relayed, all resources associated with the IP phone network 5 including the PBX 6 and the command system 7 give the highest level of priority to the flag or field of the IP packet.

Next, the operation of the emergency call system according to the first embodiment will be described. The subscriber information database 3 already has entries of the PBX 6 of the subscriber and of the command system 7 in the emergency call receiving organization. The command system 7 is served by an IP phone switching device 1b, and the PBX 6 is served by an IP phone switching device 1a. Further, the IP phone switching device 1a uses a call processing database 2a, and the IP phone switching device 1b uses a call processing database 2b. An emergency call sent from the mobile terminal 9 through the PBX 6 is received by the command system 7.

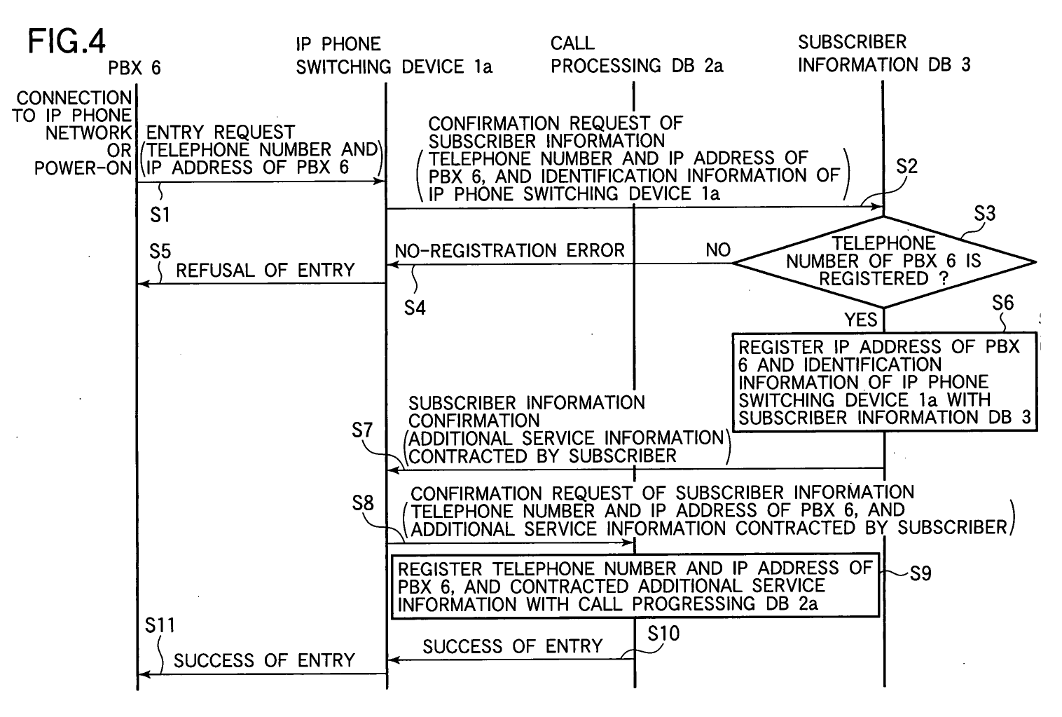

FIG. 4 is a sequence diagram showing a process of entry (or registration) of the PBX 6 to the subscriber information database 3 and the call processing database 2 in the first embodiment. A sequence of entering the PBX 6 to the subscriber information database 3 and the call processing database 2 of the IP phone network 5 will be described with reference to FIG. 4.

When the PBX 6 connected to the IP phone network 5 is turned on or the PBX 6 being turned on is connected to the IP phone network 5, the PBX 6 sends an entry request to the IP phone network 5 by the VoIP signaling protocol such as SIP (step S1), with the representative telephone number and the IP address of the PBX 6 at least. The IP phone switching device 1a, which is determined on the basis of a management area of the IP address, receives the entry request. At this time, the IP phone switching device 1a sends the subscriber information database 3 a confirmation request of the subscriber information together with the information received in step S1 and the identification information of the IP phone switching device 1a itself, in order to check that the confirmation request is coming from a subscriber (step S2). The subscriber information database 3 searches the management information in accordance with the received telephone number to check that the confirmation request is coming from a subscriber (step S3).

If the received telephone number is not registered with the subscriber information database 3, the subscriber information database 3 sends a negative reply, namely, a no-registration error signal as a reply to the confirmation request made in step S2 (step 4). The IP phone switching device 1a which received the no-registration error signal sends the PBX 6 a reply indicating the refusal of the entry of the PBX 6 because the PBX 6 that issued the entry request is not an object to be registered (step S5).

If the telephone number of the PBX 6 is found in the subscriber information database 3 in step S3, that is, the telephone number is registered with the subscriber information database 3, the IP address of the PBX 6 and the identification information of the IP phone switching device 1a that serves the PBX 6 are stored in the management area of the corresponding subscriber information in the subscriber information database 3 (step S6). The information of additional services used by the subscriber is extracted from the managed subscriber information and returned to the IP phone switching device 1a as a reply to the confirmation request in step S2 (step S7). The IP phone switching device 1a orders the call processing database 2a to store the telephone number and the IP address received from the PBX 6 and the additional service information received from the subscriber information database 3 as data for use in call processing (step S8). The call processing database 2 registers the received data in itself (step S9). If the data is registered successfully, a success of the entry is reported from the call processing database 2a to the IP phone switching device 1a (step S10) and then reported from the IP phone switching device 1a to the PBX 6 (step S11), and the entry processing ends.

When the data is registered in the subscriber information database 3 in step S6 or in the call processing database 2a in step S9, the other data areas are empty or stored by meaningless data. At the time of a complete of the entry processing, the data areas such as the IP address, the emergency call state, and the identification information of the line-hold device 4 in the call processing database 2a and the subscriber information database 3 are empty, for example.

Although the information stored in the call processing database 2a and the subscriber information database 3 is different from that in the conventional IP phone system, the operation of entry is almost the same as that in the conventional IP phone system.

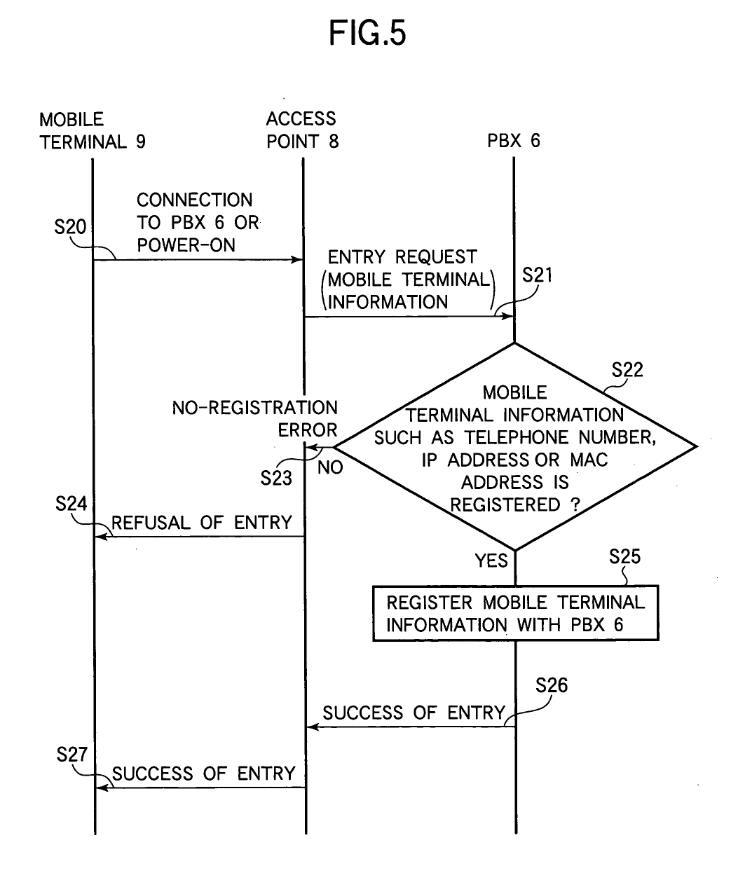

FIG. 5 is a sequence diagram showing a process of registration of the mobile terminal 9 to the PBX 6 in the first embodiment. A sequence of registering the mobile terminal 9 with the PBX 6 will be described with reference to FIG. 5.

When the mobile terminal 9 starts an operation of connection to the PBX 6 or when the off-state mobile terminal 9 is turned on, an entry request, that is, a request to shift to a communication available state, is sent through the access point 8 near the mobile terminal 9 to the PBX 6, together with the extension number, the IP address, and other identification information of the mobile terminal 9 (steps S20 and S21). The PBX 6 manages the identification information of the mobile terminal in an internal database, which is established, for example, in the emergency call storage 6a or another memory, and checks whether or not the information of the mobile terminal 9 sending the entry request is managed in the internal database (step S22).

If the information of the mobile terminal 9 sending the entry request is not managed in the PBX 6, a refusal of the entry is returned through the access point 8 to the mobile terminal 9 (steps S23 and S24).

If the information of the mobile terminal 9 sending the entry request is managed in the internal database, the PBX 6 adds the identification information of the mobile terminal 9, the information of the access point 8 serving the mobile terminal 9, and other information to a call processing database for extension terminals, which is established, for example, in the emergency call storage 6a or another memory (step S25). If the information is registered successfully, a success of the entry is reported through the access point 8 to the mobile terminal 9 (steps S26 and S27).

With these two types of sequence of entry described above, the mobile terminal 9 served by the PBX 6 becomes capable of making an emergency call to the command system 7 connected to the IP phone network 5.

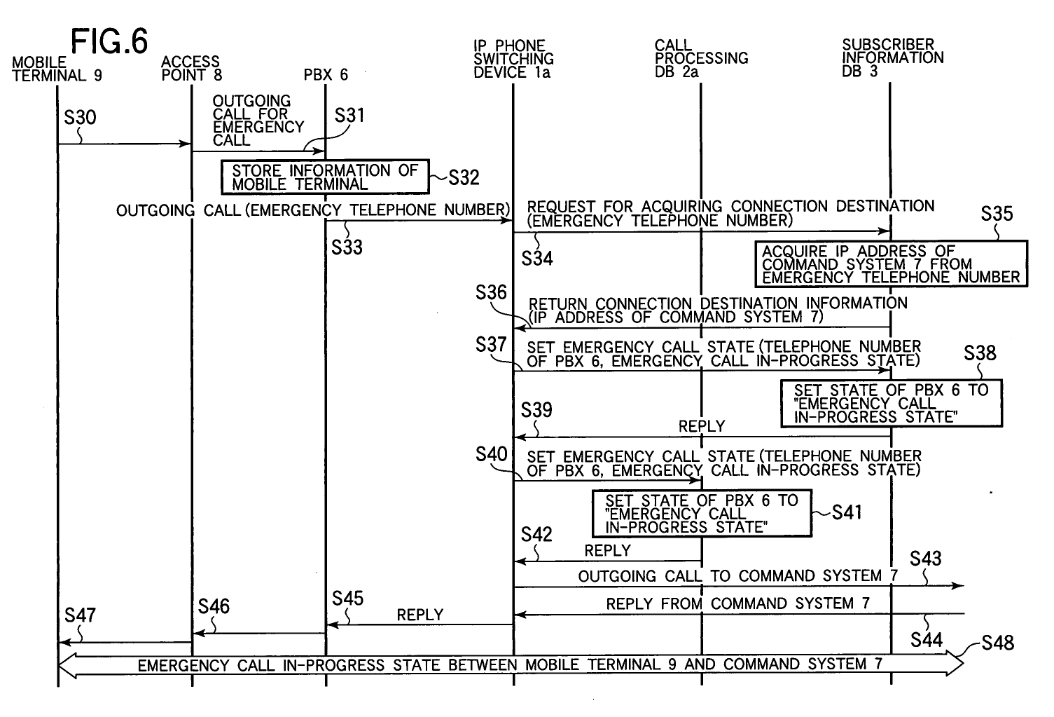

FIG. 6 is a sequence diagram showing a process performed by the emergency call system when a subscriber makes an emergency call using the mobile terminal 9 in the first embodiment. An outgoing call sequence of an emergency call from the mobile terminal 9 will be described with reference to FIG. 6.

When a person dials an emergency telephone number (for example, special numbers ‘110’, ‘118’ and ‘119’ in Japan) on the mobile terminal 9, an emergency call signal is sent through the access point 8 to the PBX 6 (steps S 30 and S31).

The PBX 6 confirms whether it serves the mobile terminal 9 of the emergency caller and stores the emergency telephone number in association with the identification information of the mobile terminal 9, such as the extension number, the IP address or the MAC address, in the emergency call storage 6a (step S32). After that, the PBX 6 places a call using the representative telephone number to the IP phone switching device 1a serving the PBX 6 by the VoIP signaling protocol (step S33).

The IP phone switching device 1a asks the subscriber information database 3 to acquire the information of the connection destination, which is the command system 7, giving the dialed emergency telephone number (step S34). The subscriber information database 3 uses the specified emergency telephone number as a search key, acquires either or both of an IP address and a telephone number assigned to the command system 7 (step S35), and returns the acquired information to the IP phone switching device 1a (step S36). Like the PBX 6, the command system 7 is assigned a telephone number for use in routing, and the subscriber information database 3 also converts the emergency telephone number to the telephone number assigned to the command system 7.

In FIG. 6, the subscriber information database 3 converts the emergency telephone number to the telephone number assigned to the command system 7. Alternatively, the IP phone switching device 1a may hold information for converting the emergency telephone number to the telephone number of the command system 7, convert the emergency telephone number into the telephone number accordingly, and ask the subscriber information database 3 to acquire information of the connection destination, giving the converted telephone number.

After the information of the connection destination, either or both of the IP address and the telephone number of the command system 7, is acquired, the IP phone switching device 1a sends the representative telephone number of the PBX 6 and the information indicating that the present status is the “emergency call in-progress state” to the subscriber information database 3 and the call processing database 3 to request them to set the “emergency call in-progress state” (steps S37 and S40). The subscriber information database 3 specifies the “emergency call in-progress state” of the PBX 6 (step S38) and returns a reply to the IP phone switching device 1a (step S39). The call processing database 2a specifies the “emergency call in-progress state” of the PBX 6 (step S41) and returns a reply to the IP phone switching device 1a (step S42).

Then, the IP phone switching device 1a issues a connection request to the command system 7 (step S43). A reply is sent from the command system 7 (step S44), and transferred to the PBX 6 (step S45). After the PBX 6 performs internal and external voice connection control, the reply is transferred from the PBX 6 through the access point 8 to the mobile terminal 9 (steps S46 and S47). An emergency call connection is then established between the mobile terminal 9 and the command system 7 (step S48).

The sequence for connecting the command system 7 uses the VoIP signaling protocol, and just the rough outline is shown in FIG. 6. FIG. 6 does not show details of normal routing, such that the request sent to the command system 7 in step S43 passes through the IP phone switching device 1b serving the command system 7.

The process of signal exchange between the PBX 6 and the mobile terminal 9 includes steps such as the return of an acknowledge signal, which are not shown in FIG. 6. FIG. 6 shows just the outline characterizing the process. The same applies to the other sequence diagrams.

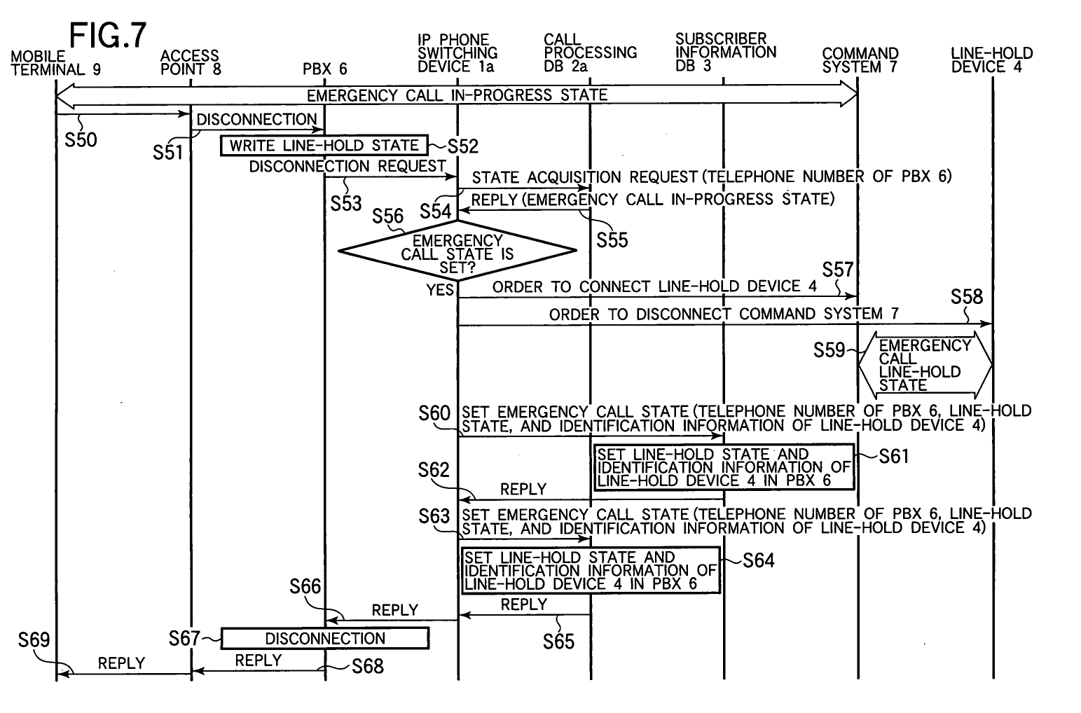

FIG. 7 is a sequence diagram showing a process performed by the emergency call system when an emergency caller disconnects an emergency call using the mobile terminal 9 in the first embodiment. A sequence of disconnecting the emergency call using the mobile terminal 9 during the “emergency call in-progress state” will be described with reference to FIG. 7.

If the mobile terminal 9 of the emergency caller becomes on-hook, namely, is disconnected when the emergency call is established, namely, during the “emergency call in-progress state”, the disconnection of the mobile terminal 9 is reported through the access point 8 to the PBX 6 (steps S50 and S51).

The PBX 6 (the controller 6c) references the emergency call storage 6a, confirms that the disconnection of the mobile terminal 9 is conducted in the “emergency call in-progress state”, and writes the information indicating that the present state is the “emergency call line-hold state” in the emergency call storage 6a (step S52). After that, the PBX 6 issues a disconnection request to the IP phone switching device 1a serving the PBX 6, using the VoIP signaling protocol (step S53).

The IP phone switching device 1a references the call state (the emergency call state) of the PBX 6 in the call processing database 2a (steps S54 and S55). If the PBX 6 is not in the “emergency call in-progress state” or the “emergency call line-hold state”, namely, if the emergency call state is vacant, a general disconnection sequence is executed, which is not illustrated in FIG. 7.

Since a disconnection request is issued when the emergency call is established, the emergency call state of the PBX 6 is “emergency call in-progress state” (step S56). Since the IP phone switching device 1a must maintain the emergency call from the emergency caller, it performs line hold processing. The IP phone switching device 1a holds the connection to the command system 7 by connecting the command system 7 to the line-hold device 4 temporarily. Accordingly, the IP phone switching device 1a orders the command system 7 to connect the line-hold device 4 (step S57) and orders the line-hold device 4 to connect the command system 7 (step S58). Although the call connection with the PBX 6 is disconnected, the command system 7 and the line-hold device 4 continue to be connected (step S59), which allows a call-back from the command system 7.

Next, the IP phone switching device 1a supplies the subscriber information database 3 with the representative telephone number of the PBX 6, the information indicating that the present state is the “emergency call line-hold state”, and the identification information of the line-hold device 4 holding the corresponding emergency call, and asks the subscriber information database 3 to set the emergency call state accordingly (step S60). The subscriber information database 3 sets the “emergency call line-hold state” of the corresponding PBX 6 and stores the identification information of the line-hold device 4 (step S61), and returns a reply (step S62). The IP phone switching device 1a also supplies the call processing database 2a with the representative telephone number of the PBX 6, the information indicating that the present state is the “emergency call line-hold state”, and the identification information of the line-hold device 4 holding the corresponding emergency call, and asks the call processing database 2a to set the emergency call state accordingly (step S63). The call processing database 2a sets the “emergency call line-hold state” of the corresponding PBX 6 and stores the identification information of the line-hold device 4 (step S64), and returns a reply (step S65).

After an updated reply is received from the both databases 3 and 2a, the IP phone switching device 1a informs the PBX 6 that the disconnection processing has ended (step S66). The IP phone switching device 1a does not execute the processing to disconnect the voice connection of the emergency call but holds the connection. For instance, the IP phone switching device 1a holds call control data related to the emergency call. This will not cause a bidirectional IP packet related to the emergency call to come, and no problem will occur. It is rather preferable because resources such as call control data to be used when a call-back instruction is made can be saved.

After the IP phone switching device 1a acknowledges that the line is held on the side of the outside line, namely, on the side of the command system 7, the PBX 6 disconnects the internal channel to the mobile terminal 9 (step S67) and sends an acknowledgement reply of disconnection through the access point 8 to the mobile terminal 9 (steps S68 and S69). The PBX 6 disconnects the internal channel of the emergency call but keeps the external channel of the emergency call. This will not cause a bidirectional IP packet associated with the emergency call to be exchanged between outside lines, and no problem will occur. It is rather preferable because resources such as call control data to be used when a call-back instruction is made can be saved.

The sequence of disconnection from the subscriber during the “emergency call in-progress state” has been described above. If a disconnection instruction is issued by the command system 7, almost the same operation as the general disconnection sequence in the IP phone system is performed. One difference is that the information of the emergency call is cleared from the databases.

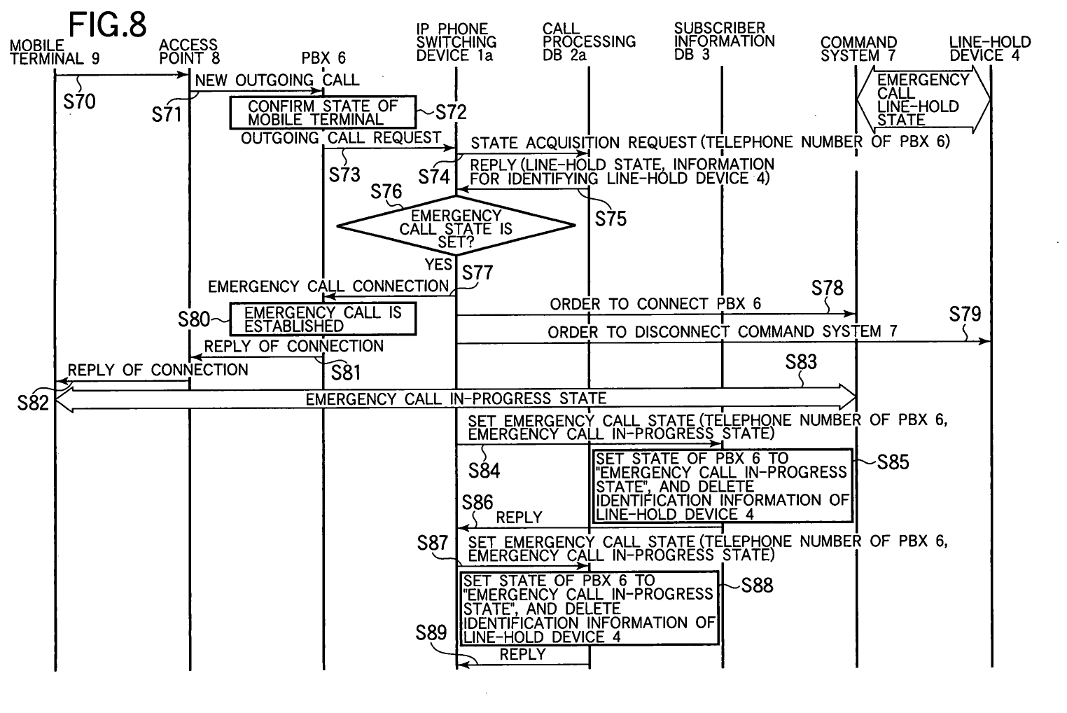

FIG. 8 is a sequence diagram showing a process performed by the emergency call system when a new outgoing call is originated from a mobile terminal during the “emergency call line-hold state” in the first embodiment. A sequence of originating a new outgoing call from the mobile terminal 9 of the emergency caller during the “emergency call line-hold state” will be described with reference to FIG. 8.

When the mobile terminal 9 is operated to originate a new outgoing call, the new outgoing call is reported through the access point 8 to the PBX 6 (steps S70 and S71). The PBX 6 (the controller 6c) references the emergency call storage 6a, confirms that the new outgoing call is directed to a third party during the “emergency call line-hold state”, and determines to connect the command system 7 forcefully (step S72). The PBX 6 asks the IP phone switching device 1a serving the PBX 6 to place a call using the VoIP signaling protocol (step S73).

The IP phone switching device 1a references the call processing database 2a and acquires the call state or emergency call state of the PBX 6 (steps S74 and S75). Since the call request is made during the “emergency call line-hold state”, it is confirmed that the PBX 6 is in the “emergency call line-hold state” (step S76). Accordingly, the IP phone switching device 1a must not allow the emergency caller to make another call, and performs the processing to connect the command system 7 to the PBX 6. In other words, the IP phone switching device 1a orders the PBX 6 to re-establish the emergency call connection (step S77), orders the command system 7 to switch the connection from the line-hold device 4 to the PBX 6 (step S78), and orders the line-hold device 4 to disconnect from the command system 7 (step S79). In the meantime, the PBX 6 updates the information of the emergency call storage 6a to express that the emergency call is in progress, re-establishes the internal emergency call connection (step S80), and sends a reply of connection through the access point 8 to the mobile terminal 9 (steps S81 and S82).

The communication line, namely, the voice connection of the emergency call is restored between the mobile terminal 9 and the command system 7 (step S83).

The IP phone switching device 1a gives the telephone number of the PBX 6 and the information indicating that the present state is the “emergency call in-progress state” to the subscriber information database 3 and asks the subscriber information database 3 to delete the identification information of the line-hold device 4 holding the “emergency call line-hold state” (step S84). The subscriber information database 3 specifies the “emergency call in-progress state” of the corresponding PBX 6 and deletes the identification information of the line-hold device 4 (step S85), and returns a reply (step S86). The IP phone switching device 1a gives the telephone number of the PBX 6 and the information indicating the emergency call system is in the “emergency call in-progress state” to the call processing database 2a and asks the call processing database 2a to delete the identification information of the line-hold device 4 holding the “emergency call line-hold state” (step S87). The call processing database 2a specifies the “emergency call in-progress state” of the corresponding PBX 6 and deletes the identification information of the line-hold device 4 (step S88), and returns a reply (step S89).

With the processing described above, the call connection with the command system 7 is restored even when the subscriber makes a call from the mobile terminal 9 to somewhere other than the command system 7 in the “emergency call line-hold state.”

In the sequence describe above, when the emergency caller makes a new outgoing call from the mobile terminal 9 during the “emergency call line-hold state”, the command system 7 is forcefully connected to the mobile terminal 9. Besides the above-described first pattern of processing, the following second and third patterns of processing are also possible.

In the second pattern, a busy tone is sent to the mobile terminal 9 regardless of the state of the desired destination of the call. When the PBX 6 checks the emergency call storage 6a and finds that the call to the third party is attempted during the “emergency call line-hold state”, the busy tone is sent to the mobile terminal 9. The busy tone may be sent from the IP phone switching device 1a or any device other than the PBX 6.

In the third pattern, a new outgoing call originated from the mobile terminal 9 of the emergency caller during the “emergency call line-hold state” is connected to the telephone terminal of the corresponding third party. When the operator of the command system 7 performs a call-back operation, the call with the third party is disconnected, and the emergency call is restored.

The third pattern will be described in further detail in the description of the second embodiment.

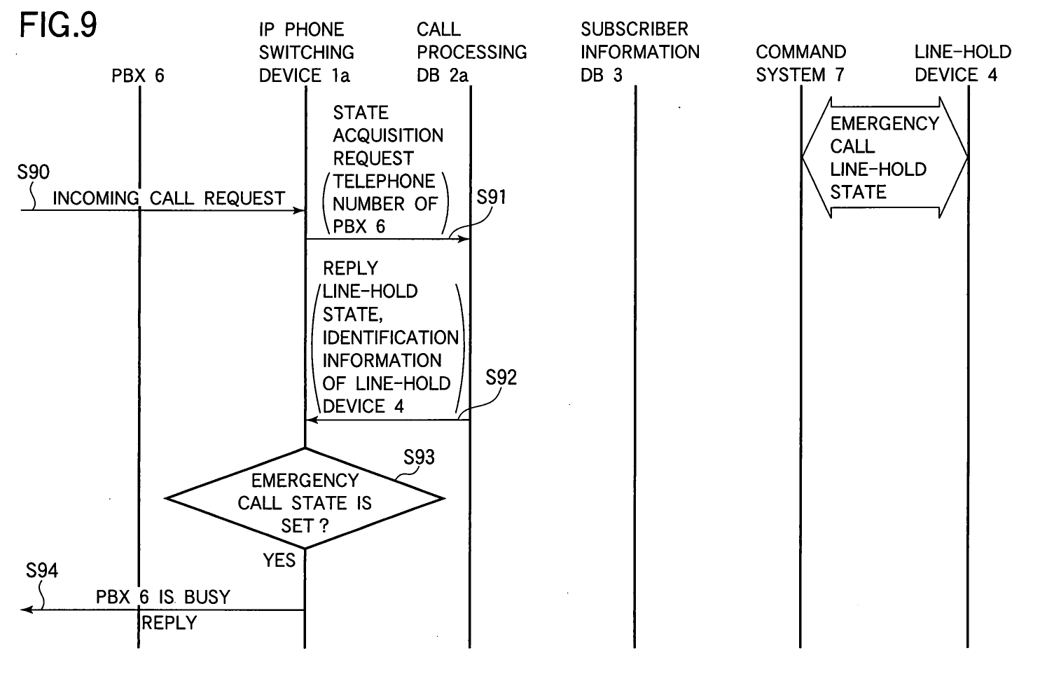

FIG. 9 is a sequence diagram showing a process performed by the emergency call system when an incoming call request to a PBX from a third party occurs during the “emergency call line-hold state” in the first embodiment. A sequence of an incoming call from a third party to the subscriber during the “emergency call line-hold state”, namely, an incoming call to the representative telephone number of the PBX 6 will be described with reference to FIG. 9.

When an incoming call request to the PBX 6 reaches the IP phone switching device 1a (step S90), the IP phone switching device 1a references the call processing database 2a (step S91) and acquires the emergency call state of the PBX 6 (step S92).

Since the incoming call request is made during the “emergency call line-hold state”, it is confirmed that the PBX 6 is in the “emergency call line-hold state” (step S93). The IP phone switching device 1a refuses the incoming call request and returns a reply telling that the PBX 6 is busy, so that the emergency call can be restored anytime by a call-back instruction from the command system 7 (step S94).

With the processing described above, if an incoming call request is made to the PBX 6 during the “emergency call line-hold state”, a busy tone is returned to the calling party even if the PBX 6 is disconnected, so that a call-back instruction from the command system 7 can be carried out any time.

Further, the above-described operation such as a busy tone reply may be performed by the PBX 6.

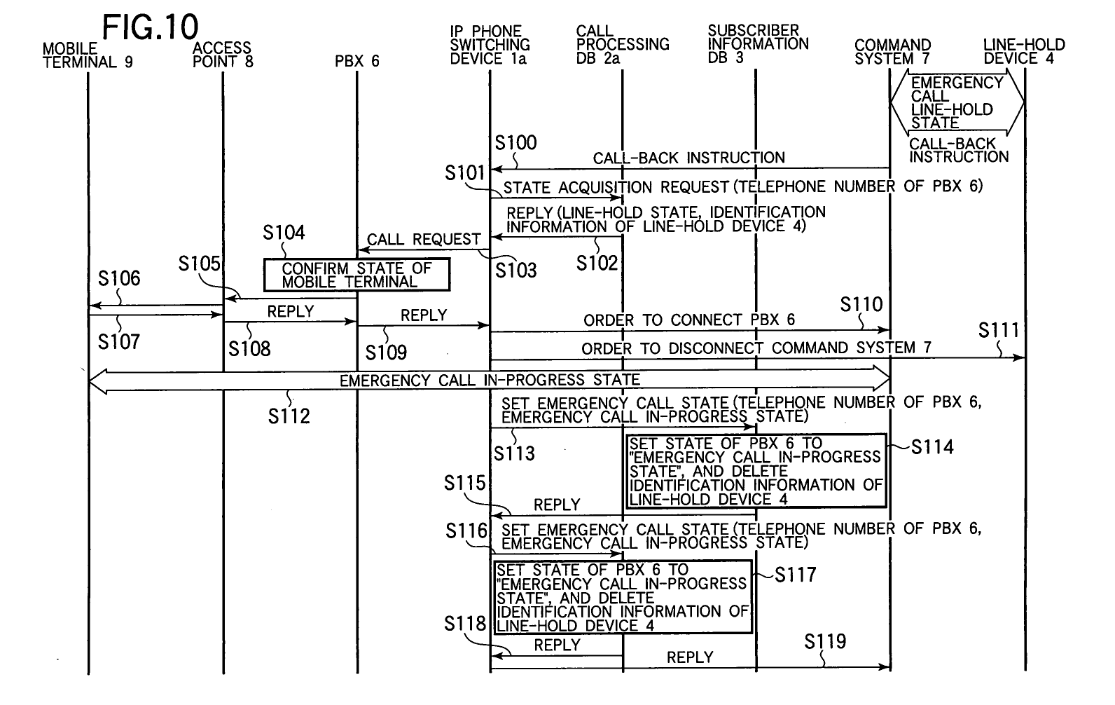

FIG. 10 is a sequence diagram showing a process performed by the emergency call system when a command system 7 in the emergency call receiving organization calls back the subscriber during the “emergency call line-hold state” in the first embodiment. A sequence of calling back the subscriber in the “emergency call line-hold state” from the command system 7 will be described with reference to FIG. 10.

When a call-back instruction is issued from the command system 7 by the operator, the call-back instruction is sent from the command system 7 to the IP phone switching device 1a (step S100). The call-back instruction is routed through the IP phone switching device 1b serving the command system 7 and the IP phone network 5a and reaches the IP phone switching device 1a. Details of this type of normal routing will not be described here. A signal sent to the command system 7 is also routed through the IP phone network 5, but details of this type of routing are not shown in FIG. 10 either.

When the call-back instruction is given, the IP phone switching device 1a references the call processing database 2a (step S101) and acquires the call state (step S102). Since the PBX 6 (the representative telephone number) is in the “emergency call line-hold state”, the IP phone switching device 1a issues a call request to the PBX 6 so that a connection between the command system 7 and the PBX 6 (or between the command system 7 and the mobile terminal 9) is restored (step S103).

The PBX 6 (the controller 6c) references the emergency call storage 6a and confirms that the emergency call connection is disconnected on the side of the extension terminal 9 (step S104). The internal emergency call path to the mobile terminal 9 is established by sending a signal through the access point 8 to the mobile terminal 9 (steps S105 and S106) and returning the signal from the mobile terminal 9 through the access point 8 to the PBX 6 (step S107 and S108). After that, the PBX 6 returns a reply to the IP phone switching device 1a (step S109).

The IP phone switching device 1a orders the command system 7 to switch its connection from the line-hold device 4 to the PBX 6 (the representative telephone number) (step S110). The IP phone switching device 1a also orders the line-hold device 4 to disconnect from the command system 7 (step S111). Accordingly, the emergency call connection between the mobile terminal 9 and the command system 7 is restored, thereby establishing “emergency call in-progress state” (step S112).

In normal call connection processing, the conditions of additional services are checked here. If a service to transfer an incoming call is used, for instance, the incoming call is connected to the specified transfer destination. However, an emergency call-back can be transmitted to the PBX 6 (the representative telephone number) of the destination, regardless of the conditions of additional services.

Next, the IP phone switching device 1a gives the representative telephone number of the PBX 6 and the information indicating the emergency call system is in the “emergency call in-progress state” to the subscriber information database 3 and asks the subscriber information database 3 to delete the identification information of the line-hold device 4 holding the emergency call (step S113). The subscriber information database 3 specifies the “emergency call line-hold state” of the corresponding PBX 6 and deletes the identification information of the line-hold device 4 (step S114), and returns a reply (step S115). The IP phone switching device 1a gives the representative telephone number of the PBX 6 and the information indicating the emergency call system is in the “emergency call in-progress state” to the call processing database 2a and asks the call processing database 2a to delete the identification information of the line-hold device 4 holding the emergency call (step S116). The call processing database 2a specifies the “emergency call in-progress state” of the corresponding PBX 6 and deletes the identification information of the line-hold device 4 (step S117), and returns a reply (step S118).

After that, the IP phone switching device 1a sends a reply of the end of the call-back processing to the command system 7, and the sequence of the call-back processing ends (step S119).

Further, the mobile terminal 9 may be moved after the emergency call is made, and when a call-back is attempted, the mobile terminal 9 may be in the management area of a different access point 8. Since the PBX 6 has the information of the access point 8 serving the mobile terminal 9 (Perch Channel), the call-back processing can be performed through the associated access point 8. It is preferable that the information of the access point 8 serving the mobile terminal 9 of the emergency caller be stored in both the management table of each device serving the mobile terminal and the emergency call storage 6a.

As has been described above, the emergency call system according to the first embodiment can appropriately implement an emergency call line-hold function and a call-back function even when an emergency call is originated from the extension terminal 9 through the PBX 6 and the IP phone network 5 using just the representative telephone number of the PBX 6 registered on the IP phone network 5. In other words, the emergency call system according to the first embodiment can appropriately implement an emergency call line-hold function and a call-back function even if the extension terminal has only an extension number and does not have a telephone number in the IP phone network 5.

Further, since the resources between the PBX 6 and the command system 7, such as call control data, are not released but held during the “emergency call line-hold state”, a failure of a call-back because of insufficient resources can be prevented.

Furthermore, when the mobile terminal 9 in the “emergency call line-hold state” attempts to make a new call to a third party, the command system 7 is connected forcefully. Alternatively, a busy tone is returned regardless of the state of the third party. Accordingly, a call-back can be made any time.

### Second Embodiment

An emergency call system according to the second embodiment of the present invention will be described below with reference to the drawings. The description presented below mainly concerns differences from the emergency call system according to the first embodiment.

Except for some differences described below, the emergency call system according to the second embodiment has the same configuration as the emergency call system according to the first embodiment. The second embodiment differs from the first embodiment in the processing when a new outgoing call is originated from the mobile terminal 9 of the emergency caller during the “emergency call line-hold state.” The emergency call system according to the second embodiment is the third pattern described earlier.

When a new outgoing call is originated from the mobile terminal 9 of the emergency caller during the “emergency call line-hold state”, the new call is connected to the telephone terminal of the third party in the second embodiment. When the operator of the command system 7 carries out a call-back operation during the established new call between the emergency caller and the third party, the established new call between the emergency caller and the third party is disconnected and the emergency call connection between the emergency caller and the command system is restored forcefully.

In the second embodiment, when a new outgoing call is originated from the mobile terminal 9 of the emergency caller to the third party during the “emergency call line-hold state”, the communication channel to the third party is established. Since the communication channel between the mobile terminal 9 of the emergency caller and the third party is established through a general sequence of call processing, the sequence is not described here.

The fact that the mobile terminal 9 of the emergency caller is being connected to the third party and the identification information of the third party, such as the telephone number and IP address, are written in the emergency call storage 6a of the PBX 6. If a line used by the third party is an outside line, a PBX 6 having a plurality of representative telephone numbers enables this type of connection. The subscriber information and the registered subscriber information of a representative telephone number used to call the third party is written in the call processing database 2a and the subscriber information database 3 respectively.

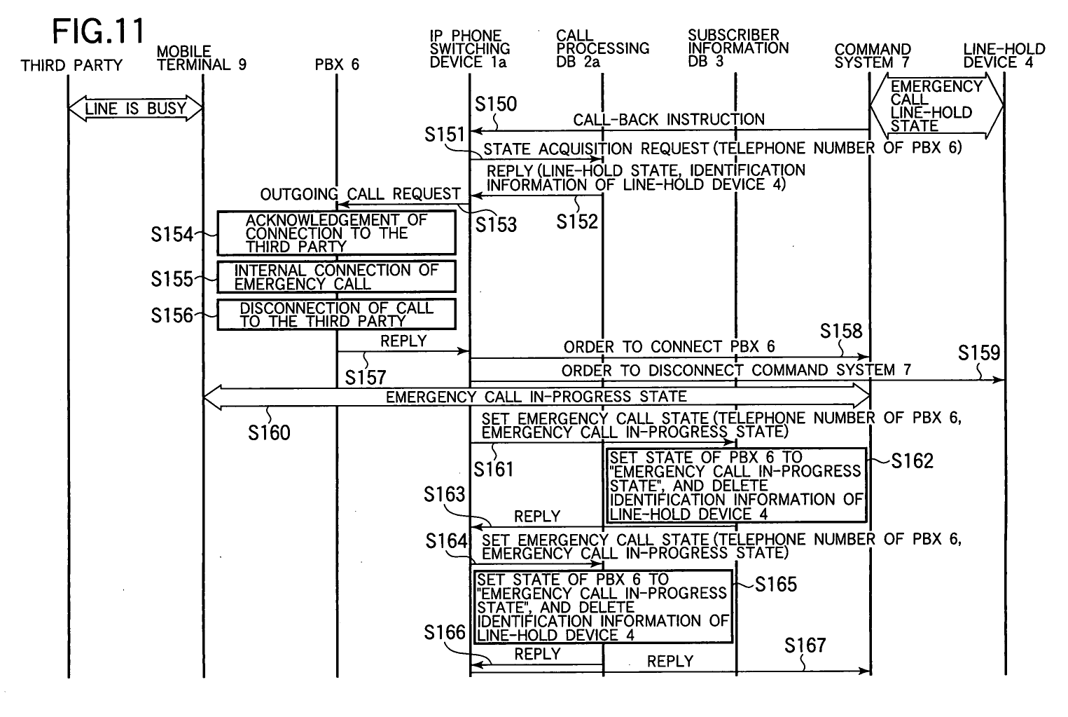

FIG. 11 is a sequence diagram showing a process performed by the emergency call system when a command system 7 in the emergency call receiving organization calls back a subscriber, whose mobile phone 9 is busy with a call between the subscriber and the third party, during the “emergency call line-hold state” in the second embodiment of the present invention. A sequence of addressing a call-back instruction while the mobile terminal 9 of the emergency caller in the “emergency call line-hold state” is being connected to the third party will be described with reference to FIG. 11. The diagram shown in FIG. 11 corresponds to the diagram shown in FIG. 10 of the first embodiment. Although the access point 8 exists between the mobile terminal 9 and the PBX 6 and relays a signal between them, the diagram shown in FIG. 11 is simplified by omitting the access point 8.

When a call-back instruction is issued from the command system 7 by the operator, the call-back instruction is sent from the command system 7 to the IP phone switching device 1a (step S150).

When the call-back instruction is given, the IP phone switching device 1a references the call processing database 2a (step S151) and acquires the call state (step S152). Since the PBX 6 (the representative telephone number) is in the “emergency call line-hold state”, the IP phone switching device 1a issues an outgoing call request to the PBX 6 (step S153) so that a connection between the command system 7 and the PBX 6 (or between the command system 7 and the mobile terminal 9) is restored.

With reference to the emergency call storage 6a, the PBX 6 acknowledges that the mobile terminal 9 of the emergency caller is being connected with the third party (step S154). The PBX 6 connects the mobile terminal 9 internally to the representative telephone number used for the emergency call (step S155) and disconnects the third party (another representative telephone number) forcefully (step S156). The PBX 6 returns a reply to the IP phone switching device 1a (step S157).

The IP phone switching device 1a orders the command system 7 to switch its connection from the line-hold device 4 to the PBX 6 (the representative telephone number) (step S158). The IP phone switching device 1a also orders the line-hold device 4 to disconnect from the command system 7 (step S159). Accordingly, the emergency call connection between the mobile terminal 9 and the command system 7 is restored, thereby establishing the “emergency call in-progress state” (step S160).

The IP phone switching device 1a gives the representative telephone number of the PBX 6 and the information indicating the emergency call system is in the “emergency call in-progress state” to the subscriber information database 3 and asks it to delete the identification information of the line-hold device 4 holding the emergency call (step S161). The subscriber information database 3 specifies the “emergency call in-progress state” of the associated PBX 6 and deletes the identification information of the line-hold device 4 (step S162), and returns a reply to the IP phone switching device 1a (step S163). The IP phone switching device 1a gives the representative telephone number of the PBX 6 and the information indicating the emergency call system is in the “emergency call in-progress state” to the call processing database 2a and asks it to delete the identification information of the line-hold device 4 holding the emergency call (step S164). The call processing database 2a specifies the “emergency call in-progress state” of the associated PBX 6 and deletes the identification information of the line-hold device 4 (step S165), and returns a reply (step S166).

After that, the IP phone switching device 1a sends a reply of the end of the call-back processing to the command system 7, and the sequence of the call-back processing ends (step S167).

As described above, the emergency call system of the second embodiment produces almost the same effect as the emergency call system of the first embodiment, and also allows the mobile terminal of the emergency caller in the “emergency call line-hold state” to be connected to a third party.

### Other Embodiments

In addition to modifications to the embodiments that have been described above, the following modified embodiments are possible.

In the embodiments described above, the line-hold device 4 is used to hold a line between the PBX 6 and the command system 7, but the “emergency call line-hold state” may be established by using a function of the PBX 6, without using the line-hold device 4. The PBX 6 has an inside channel configuration connected via the inside line to an inside equipment such as the access point 8 and the mobile terminal 9 and an outside channel configuration connected via the outside line to a public network such as the IP phone network 5. When the mobile terminal 9 issues a disconnection request, the PBX 6 may disconnect the inside channel, without disconnecting the outside channel, so that the PBX 6 establishes the “emergency call line-hold state.”

The subscriber information database 3 in the embodiments described above may be configured by a plurality of servers.

Further, the call processing database 2 (2a and 2b) and the IP phone switching device 1 may be configured physically by a single server.

Furthermore, the data of the call processing database 2 (2a and 2b) may be on the main memory of the IP phone switching device 1 after the IP phone switching device 1 is rebooted, and the subscriber information database 3 may be accessed each time the need arises.

Moreover, the subscriber information database 3 and the call processing database 2 (2a and 2b) are isolated in the embodiments described above, but these databases may be integrated into a single database if the functions of the subscriber information database 3 and the call processing database 2 (2a and 2b) can be performed as described above.

In the embodiments descried above, although a combination of the telephone number and IP address of a subscriber is used as the identification information of the subscriber in the database for the purpose of antispoofing, some other information can be used to identify the subscriber. A combination of the SIP-URI and IP address can be used as the identification information of the subscriber in the database, for instance.

Further, when the PBX 6 is connected to the IP phone network 5, an IP address can be assigned by any protocol such as the Dynamic Host Configuration Protocol (DHCP) or the Point to Point Protocol (PPP).

In the embodiments described above, although the call control protocol used in the IP phone network 5 is the SIP, any other call control protocol such as the Media Gateway Control Protocol (MGCP) can be used.

Furthermore, although the extension terminal is a wireless mobile terminal 9 in the embodiments described above, the present invention can be applied to a case where the extension terminal is a wired terminal as well.

Moreover, although the present invention is suitable for a case where a telephone network is the IP phone network, the present invention can be applied to a case where a telephone network is other public networks as well.

The invention being thus described, it will be obvious that the same may be varied in many ways. Such variations are not to be regarded as a departure from the spirit and scope of the invention, and all such modifications as would be obvious to one skilled in the art are intended to be included within the scope of following claims.

What is claimed is:

1. An emergency call system comprising a private branch exchange assigned a representative telephone number;
the private branch exchange including:
a channel section which connects or disconnects channels to a plurality of extension terminals, connects or disconnects a channel to a public network, and establishes a channel between the plurality of extension terminals and the public network;
a storage which stores emergency call information including identification information of the plurality of extension terminals; and
a controller which controls an operation of the channel section and the storage;
wherein when any of the plurality of extension terminals originates an emergency call using the representative telephone number of the private branch exchange to a command system assigned an emergency telephone number, the channel section establishes a channel which enables communication between an emergency call extension terminal which is the extension terminal originating the emergency call and the command system, and the storage stores identification information of the emergency call extension terminal and emergency call in-progress state information indicating the emergency call communication between the emergency call extension terminal and the command system is in progress;
wherein when the emergency call extension terminal disconnects the emergency call during the emergency call in-progress state, the channel section disconnects a channel to the emergency call extension terminal and keeps connecting a channel to the public network, thereby establishing an emergency call line-hold state, the storage stores emergency call line-hold state information and deletes the emergency call in-progress state information.

2. The emergency call system according to claim 1, further comprising:
a subscriber information database which contains subscriber information of a subscriber to a telephone service in the public network;
a call processing database which contains registered subscriber information of a registered subscriber whose private branch exchange is connected to public network and turned on;
a line-hold device which holds a line between the private branch exchange and the command system during the emergency call line-hold state; and
an IP phone switching device which is connected to the public network and switches a connection among the private branch exchange, the subscriber information database, the call processing database, the line-hold device, and the command system.

3. The emergency call system according to claim 2, wherein the subscriber information database and the call processing database are integrated into a single database.

4. The emergency call system according to claim 2, wherein the subscriber information database and the call processing database are incorporated into the IP phone switching device.

5. The emergency call system according to claim 2, wherein the line-hold device is incorporated into the IP phone switching device.

6. The emergency call system according to claim 2, wherein the line-hold device is incorporated into the private branch exchange.

7. The emergency call system according to claim 1, wherein when the command system makes a call-back to the emergency call extension terminal during the emergency call line-hold state, the channel section establishes a channel which enables communication between the emergency call extension terminal and the public network, and the storage stores the emergency call in-progress state information and deletes the emergency call line-hold state information.

8. The emergency call system according to claim 2, wherein when the command system makes a call-back to the emergency call extension terminal during the emergency call line-hold state, the channel section establishes a channel which enables communication between the emergency call extension terminal and the command system, the storage stores the emergency call in-progress state information and deletes the emergency call line-hold state information, and the IP phone switching device establishes a connection between the private branch exchange and the command system.

9. The emergency call system according to claim 1, wherein when the emergency call extension terminal originates a new outgoing call during the emergency call line-hold state, the channel section establishes a channel which enables communication between the emergency call extension terminal and the command system, and the storage stores the emergency call in-progress state information and deletes the emergency call line-hold state information.

10. The emergency call system according to claim 2, wherein when the emergency call extension terminal originates a new outgoing call during the emergency call line-hold state, the channel section establishes a channel which enables communication between the emergency call extension terminal and the command system, the storage stores the emergency call in-progress state information and deletes the emergency call line-hold state information, and the IP phone switching device establishes a connection between the private branch exchange and the command system.

11. The emergency call system according to claim 2, wherein when the channel section receives a new incoming call from another terminal connected to the public network during the emergency call line-hold state, the IP phone switching device sends back a busy tone to the another terminal.

12. The emergency call system according to claim 2, wherein when the extension terminal originates a new outgoing call to another terminal connected to the public network during the emergency call line-hold state, the IP phone switching device connects the extension terminal originating a new outgoing call to the another terminal.

13. The emergency call system according to claim 2, wherein when the extension terminal originates a new outgoing call to another terminal connected to the public network during the emergency call line-hold state, the IP phone switching device sends a busy tone to the extension terminal.
